(19) United States
(12) Patent Application Publication
(10) Pub. No.: US 2008/0082957 A1
(43) Pub. Date: Apr. 3, 2008

(54) Method for improving the control of a project as well as device suitable for this purpose

(76) Inventors: Andrej Pietschker, Munchen (DE); Markus Warken, Laupheim (DE)

Correspondence Address: HARNESS, DICKEY & PIERCE, P.L.C., P.O.BOX 8910, RESTON, VA, 20195, US

(21) Appl. No.: 11/606,890

(22) Filed: Dec. 1, 2006

(30) Foreign Application Priority Data
Sep. 29, 2006 (DE) 10 2006 046 221.1

(51) Int. Cl. G06F 9/44

(52) U.S. Cl. 717/101

(57) ABSTRACT

A method is disclosed for improving the control of a project features. The method, in at least one embodiment, includes definition of a Bayesian network, by modeling as external nodes of the Bayesian network each project variable of the project able to be measured and/or influenced, and defining dependencies between the modeled nodes; executing an assignment process by which project variable values which show possible values of the project variables which represent the nodes are assigned to the modeled nodes; calculation of a project variable value of a child project variable based on project variable values of assigned parent project variables and the defined dependencies of the child project variable on the at least one parent project variable, and control of the project using the calculated project variable value.

### PRIORITY STATEMENT

The present application hereby claims priority under 35 U.S.C. §119 on German patent application number DE 10 2006 046 221.1 filed Sep. 29, 2006, the entire contents of which is hereby incorporated herein by reference.

### FIELD

Embodiments of the invention generally relate to improving the control of a project, and/or to a device suitable for this purpose.

### BACKGROUND

The complexity of technical projects, especially in the software area, has continued to increase in recent years. It is common for several hundred software engineers to be working on a software project simultaneously. Project control has a central role to play in these types of software project.

### SUMMARY

In at least one embodiment of the invention, a method is specified for simplifying the control of complex projects.

In accordance with at least one embodiment of the invention a method for improving the control of a project is provided, the method including:

Definition of a Bayesian network, by modeling as external nodes of the Bayesian network each project variable of the project able to be measured and/or influenced, and by defining dependencies between the modeled nodes,

Executing an assignment process by which project variable values which show possible values of the project variables which the nodes represent are assigned to the modeled nodes.

Calculating the project variable values of at least one project variable based on project variable values of at least one other project variable and the defined dependencies between the project variables, and

Controlling the project using the calculated project variable values.

In accordance with at least one embodiment of the invention, the Bayesian network is trained by project variable values of earlier projects and/or project variable values of a current project.

In accordance with at least one embodiment of the invention, each child project variable is allocated a probability distribution, which assigns probability values to the project variable values which the associated parent project variables can assume, with the probability values specifying the probability with which, if certain project variable values of the parent project variables are present, specific project variable values of the child project variable will occur.

In accordance with at least one embodiment of the invention, the Bayesian network is trained by changing the probability distributions allocated to the child project values.

In accordance with at least one embodiment of the invention, external nodes are modeled for the project variables time, quality and costs.

In accordance with at least one embodiment of the invention, a method for improving the control of a project is provided, the method including:

Definition of a Bayesian network, by modeling as external nodes of the Bayesian network each project variable of the project able to be measured and/or influenced, and defining dependencies between the modeled nodes,

Executing an assignment process by which project variable values which show possible values of the project variables which the nodes represent are assigned to the modeled nodes,

Determining the sensitivity of a first project variable in respect of a second project variable by determining how greatly a project variable value of the first child project variable changes when a project variable value of the second project variable changes,

Control of the project using the sensitivity calculated.

The determination of the sensitivities makes it possible for example to decide on those project values to which the project reacts especially sensitively. If project variable values can be assigned to the project variables, particular attention can then be paid to the project variable values belonging to sensitive project variables (an exact determination is necessary), and less attention paid to the project variable values which belong to non-sensitive project variables (an imprecise determination is sufficient). This means that when the BBN is “fed” with data, focal points can be set, thus saving time and money in determination of project variable values.

In accordance with at least one embodiment of the invention, the first project variable is allocated a mathematical function, which describes the first project variable and is a function of the project variable value of the second project variable.

In accordance with at least one embodiment of the invention the sensitivity of the first project variable is calculated by deriving the mathematical function of the first project variable partly according to the second project variable, with the partial deviation representing the sensitivity.

In accordance with at least one embodiment of the invention, a method for evaluation of the quality of a project control method is provided, by calculating project variable values of first project variables depending on project variable values of second project variables, the method including:

Definition of a Bayesian network by modeling as external nodes of the Bayesian network at least one first project variable of the project control method to be evaluated as well as a project control method evaluation figure to be calculated and defining dependencies between the modeled external nodes,

Executing a calculation process through which the project variable values of the at least one first project variable are calculated by the project control method to be evaluated, and

Calculation of the project control evaluation figure, based on the calculated project variable values, which represents a measure for the quality of the project control method.

In accordance with at least one embodiment of the invention, for each first project variable which was modeled as an external node, a further external node is modeled to which a measured project variable value of the first project variable is assigned, with dependencies being defined between the further external nodes and the already modeled nodes.

In accordance with at least one embodiment of the invention, the project control methods to be modeled comprise:

Definition of a Bayesian network, by modeling as external nodes of the Bayesian network each project variable of the project able to be measured and/or influenced, and by defining dependencies between the modeled nodes,

Executing an assignment process by which project variable values which show possible values of the project variables which the nodes represent are assigned to the modeled nodes,

Calculating the project variable values of at least one first project variable based on project variable values of a second project variable and the defined dependencies between the project variables, and

Control of the project using the calculated project variable values.

In accordance with at least one embodiment of the invention, all child project variables and all parent project variables of the project control method to be evaluated are modeled as external nodes.

In accordance with at least one embodiment of the invention, the Bayesian network is trained by data records containing calculated project variable values and measured project variable values as well as measured project control method evaluation figures of earlier projects and/or of the current projects.

In accordance with at least one embodiment of the invention, each child project variable is allocated a probability distribution, which assigns probability values to the project variable values which the associated parent project variables can assume, with the probability values specifying the probability with which, if certain project variable values of the parent project variables are present, specific project variable values of the child project variable will occur.

In accordance with at least one embodiment of the invention, the Bayesian network is trained by changing the probability distributions allocated to the child project values.

In accordance with at least one embodiment of the invention, a device for improving the project control of a project is provided, with:

Means for definition of a Bayesian network, through which each project variable of the project able to be measured and/or influenced is able to be modeled as an external node of the Bayesian network, and dependencies between the modeled nodes are able to be defined,

Means for executing an assignment process by which project variable values which show possible values of the project variables which represent the nodes are assigned to the modeled nodes,

Means for calculating the project variable values of at least one project variable based on project variable values of at least one other project variable and the defined dependencies between the project variables, and

Means for control of the projects using the calculated project variable values.

In accordance with at least one embodiment of the invention, the Bayesian network is trained by project variable values of earlier projects and/or project variable values of a current project.

In accordance with at least one embodiment of the invention, each child project variable is allocated a probability distribution, which assigns probability values to the project variable values which the associated parent project variables can assume, with the probability values specifying the probability with which, if certain project variable values of the parent project variables are present, specific project variable values of the child project variable will occur.

In accordance with at least one embodiment of the invention, the Bayesian network is able to be trained by changing the probability distributions allocated to the child project values.

In accordance with at least one embodiment of the invention, external nodes are modeled for the project variables time, quality and costs.

In accordance with at least one embodiment of the invention, a device for improving the project control of a project is provided, with:

Means for definition of a Bayesian network, through which each project variable of the project able to be measured and/or influenced is able to be modeled as an external node of the Bayesian network, and dependencies between the modeled nodes are able to be defined,

Means for executing an assignment process by which project variable values which show possible values of the project variables which represent the nodes are assigned to the modeled nodes,

Means for determining the sensitivity of a first project variable in respect of a second project variable by determining how greatly a project variable value of the first child project variable changes when a project variable value of the second project variable changes,

Means for control of the projects using the calculated sensitivity.

In accordance with at least one embodiment of the invention, the first project variable is allocated a mathematical function which describes the first project variable and is a function of the project variable value of the second project variable.

In accordance with at least one embodiment of the invention, the sensitivity of the first project variable is calculated by deriving the mathematical function of the first project variable partly according to the second project variable, with the partial derivation representing the sensitivity.

In accordance with at least one embodiment of the invention a device for evaluation of the quality of a project control method is provided, by calculating project variable values of first project variables depending on project variable values of second project variables, with

Means for definition of a Bayesian network, through which at least one first project variable of the project control method to be evaluated as well as a project control evaluation method to be calculated are able to be modeled as external nodes of the Bayesian network and dependencies between the modeled external nodes are able to be defined,

Means for executing a calculation process through which the project variable values of the at least one first project variable are calculated by the project control method to be evaluated, and through which, based on the calculated project variable values, the project control evaluation figure is calculated which represents a measure of the quality of the project control method.

In accordance with at least one embodiment of the invention, a further external node is able to be modeled by the means for definition of a Bayesian network for each first project variable which was modeled as an external node, to which a measured project variable value is assigned, with dependencies being able to be defined between the further external nodes and already modeled nodes.

In accordance with at least one embodiment of the invention, the project control methods to be modeled comprise:

Definition of a Bayesian network, by modeling as external nodes of the Bayesian network each project variable of the project able to be measured and/or influenced, and by defining dependencies between the modeled nodes,

Executing an assignment process through which project variable values which show possible values of the project variables which the nodes are assigned to the modeled nodes,

Calculating the project variable values of at least one first project variable based on project variable values of a second project variable and the defined dependencies between the project variables, and

Control of the project using the calculated project variable values.

In accordance with at least one embodiment of the invention, all child project variables and all parent project variables of the project control method to be evaluated are able to be modeled as external nodes by a device/system/program/module for definition of a Bayesian network.

In accordance with at least one embodiment of the invention, the Bayesian network is able to be trained by data records containing calculated project variable values and measured project variable values as well as measured project control method evaluation figures of earlier projects and/or of the current project.

In accordance with at least one embodiment of the invention, each child project variable is allocated a probability distribution, which assigns probability values to the project variable values which the associated parent project variables can assume, with the probability values specifying the probability with which, if certain project variable values of the parent project variables are present, specific project variable values of the child project variable will occur.

In accordance with at least one embodiment of the invention, the Bayesian network is able to be trained by changing the probability distributions allocated to the child project values.

In accordance with at least one embodiment of the invention, a computer program product (or computer readable medium including programs or program modules) is provided which is designed to execute a method for improving the project control of a project when executed on a computer or a DSP, which has the following:

Definition of a Bayesian network, by modeling as external nodes of the Bayesian network each project variable of the project able to be measured and/or influenced, and defining dependencies between the modeled nodes,

Executing an assignment process by which project variable values which show possible values of the project variables which represent the nodes are assigned to the modeled nodes,

Calculating the project variable values of at least one project variable based on project variable values of at least one other project variable and the defined dependencies between the project variables, and

Control of the project using the calculated project variable values.

In accordance with at least one embodiment of the invention, a computer program product (or computer readable medium including programs or program modules) is provided which is designed to execute a method for improving the project control of a project when executed on a computer or a DSP, which has the following:

Definition of a Bayesian network, by modeling as external nodes of the Bayesian network each project variable of the project able to be measured and/or influenced, and defining dependencies between the modeled nodes,

Executing an assignment process by which project variable values which show possible values of the project variables which represent the nodes are assigned to the modeled nodes,

Determining the sensitivity of a first project variable in respect of a second project variable by determining how much a project variable value of the first child project variable changes when a project variable value of the second project variable changes,

Control of the project using the sensitivity calculated.

In accordance with at least one embodiment of the invention, a computer program product (or computer readable medium including programs or program modules) is provided which is designed, when executed on a computer or a DSP, to execute a method for evaluation of quality of a project control method, in which project variable values of first project variables are calculated depending on project variable values of second project variables, with the following:

Definition of a Bayesian network, in that at least one first project variable of the project control method to be evaluated as well as a project control evaluation method to be calculated are modeled as external nodes of the Bayesian network and dependencies between the modeled external nodes are defined,

Executing a calculation process through which the project variable values of the at least one first project variable are calculated by the project control method to be evaluated, and

Calculation of the project control evaluation figure based on the calculated project variable values which represents a measure for the quality of the project control method.

### BRIEF DESCRIPTION OF THE DRAWINGS

The invention is explained in more detail below with reference to the enclosed Figures on the basis of example embodiments. The figures show:

FIG. 1 a flowchart of a first embodiment of the inventive method;

FIG. 2 a flowchart of a second embodiment of the inventive method;

FIG. 3 a flowchart of a third embodiment of the inventive method;

FIG. 4 a schematic diagram of a first embodiment of a Bayesian network, which can be used in the inventive method;

FIG. 5 a schematic diagram of a second embodiment of a Bayesian network, which can be used in the inventive method;

FIG. 6 a schematic diagram of a third embodiment of a Bayesian network, which can be used in the inventive method;

FIG. 7 a schematic diagram of a fourth embodiment of a Bayesian network, which can be used in the inventive method;

Areas with identical areas or areas which correspond to one another are shown in the figures by the same reference symbols.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

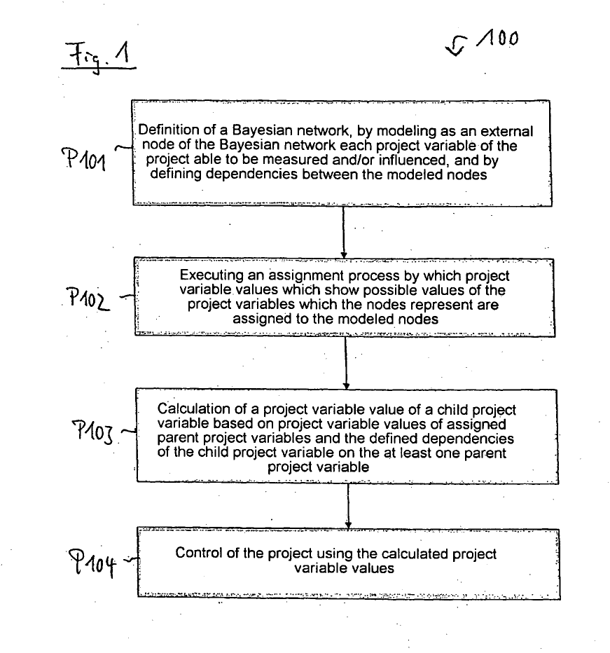

FIG. 1 shows a first embodiment 100 of the inventive method for improving the control of a project, featuring the following processes: In a first process P101 a Bayesian network is defined by modeling as external nodes of the Bayesian network each project variable of the project able to be measured and/or influenced, and by defining dependencies between the modeled nodes. In a second process P102 an assignment process is executed by which project variable values which show possible values of the project variables which represent the nodes are assigned to the modeled nodes, In a third process P103 a project variable value of a child project variable is calculated based on project variable values of assigned parent project variables and the defined dependencies of the child project variable on the at least one parent project variable. In a fourth process P104 the project is controlled using the calculated project variable value.

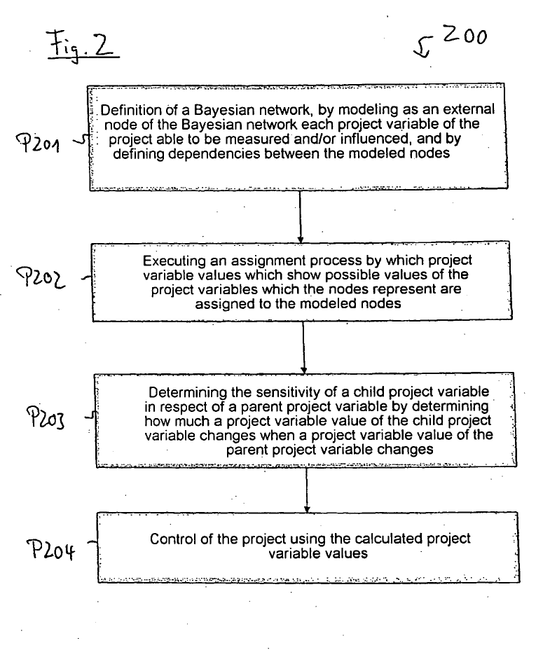

FIG. 2 shows a second embodiment 200 of the method in accordance with the invention for improving the project control of a project, featuring the following processes: In a first process P201 a Bayesian network is defined by modeling as external nodes of the Bayesian network each project variable of the project able to be measured and/or influenced, and defining dependencies between the modeled nodes. In a second process P202 an assignment process is executed by which project variable values which show possible values of the project variables which represent the nodes are assigned to the modeled nodes. In a third process P203 the sensitivity a child project variable in relation to a parent project variable is calculated by determining how much a project variable value of the child project variable changes when a project variable value of the parent project is changed. In a fourth process P204 the project is controlled using the calculated sensitivities.

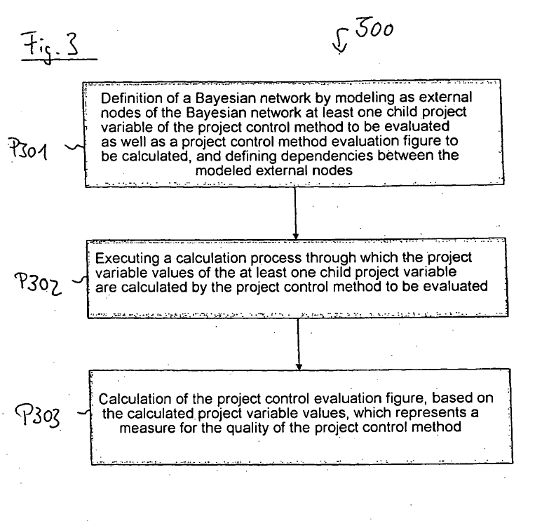

FIG. 3 shows a third embodiment 300 of the inventive method which is used for evaluation of the quality of a project control method, in which project variable values of child project are calculated depending on project variable values of parent project variables, with the following processes: In a first process P301 a Bayesian network is defined by modeling at least one child project variable of the project control method to be evaluated as well as a project control method evaluation number to be calculated as external nodes of the Bayesian network and by defining dependencies between the modeled external nodes. In a second process P302 a calculation process is executed, by which the project variable values of the at least one child project variable are calculated by the project control method to be evaluated. In a third process P303, based on the calculated project variable values the project control method is calculated, which represents a measure for the quality of the project control method.

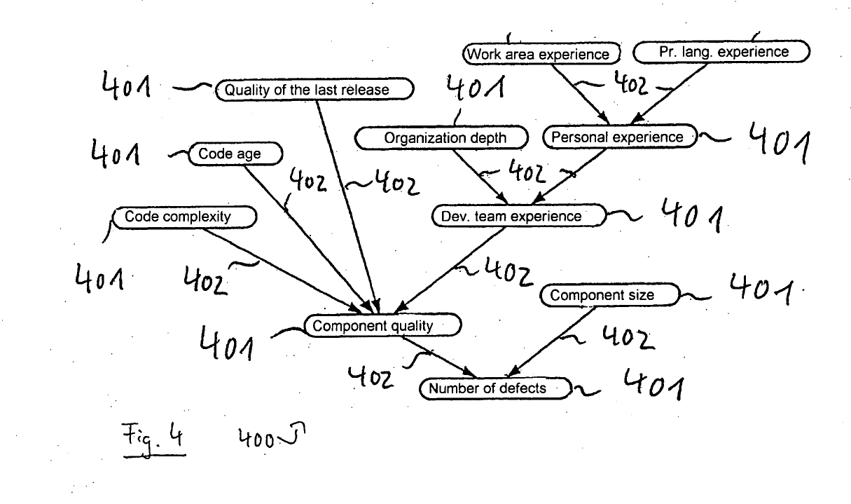

FIG. 4 shows a first embodiment of a Bayesian network 400. The Bayesian network 400 has a number of external nodes 401 which represent all project variables of a project. The Bayesian network thus provides a map of a project. The external nodes 401 are dependent on each other, a relationship which is indicated by arrows. The directions of the arrows symbolize directions of the dependencies 402. Thus for example the project variable “Number of defects” depends on the project variables “Component quality” and “Component size”. The project variables of those nodes 401 in which arrows end, are child project variables, whereas the project variables of those nodes from which arrows originate are parent project variables. Project variables can be both child project variables and also parent project variables.

In accordance with an embodiment of the invention a method for improving the control of a project is provided, with the following steps:

Definition of a Bayesian network 400, by modeling as external nodes 401 of the Bayesian network each project variable of the project able to be measured and/or influenced, and defining dependencies 402 between the modeled nodes 401,

Executing an assignment process by which project variable values which show possible values of the project variables which represent the nodes 401 are assigned to the modeled nodes 401,

Calculation of a project variable value of a child project variable based on project variable values of assigned parent project variables and the defined dependencies 402 of the child project variable on the at least one parent project variable, and

Control of the project using the calculated project variable values.

In the example shown in FIG. 4 for example project variable values of the child project variables “Personal experience”, “dev. team experience”, “Component quality” and also “Number of defects” can be calculated.

In accordance with an embodiment of the invention, each child project variable is allocated a probability distribution, which assigns probability values to the project variable values which the associated parent project variables can assume, with the probability values specifying the probability with which, if certain project variable values of the parent project variables are present, specific project variable values of the child project variable will occur. This makes it possible to train the Bayesian network 400 by project variable values of earlier projects and/or project variable values of a current project: The Bayesian network 400 is for example trained by changes being made to the probability distributions assigned to the child project variables.

In accordance with one embodiment of the invention, the sensitivity of a child project variable is determined in relation to a parent project variable by determining how much a project variable value of the child project changes when a project variable value of the parent project changes. For example the extent to which the project variable value of the project variable “Component quality” changes depending on the project variable value of the project variable “Age of code” can be determined. To this end, in accordance with one embodiment of the invention the child project variable “Component quality” is assigned a mathematical function which describes the child project variable and is a function of the project variable value of the parent project variable “Age of code”. The sensitivity of the child project variable is calculated by partly deriving the mathematical function of the child project variable “Component quality” according to the parent project variable “Age of code”, with the partial derivation representing the sensitivity.

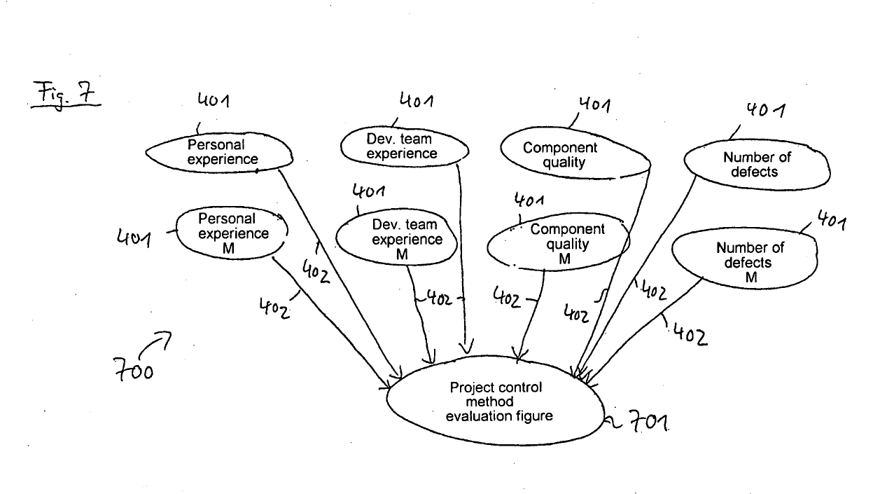

FIG. 7 shows a method with which the quality of the project control method which is symbolized by the Bayesian network 400 can be evaluated. The method features the following processes:

Definition of a Bayesian network 700, in that the child project variables (here “Personal experience”, “Dev team experience”, “Component quality” and also “Number of defects”) of the project control method to be evaluated as well as a project control method evaluation figure to be calculated 701 are modeled as external nodes 401 of the Bayesian network 700 and dependencies 402 between the modeled external nodes 401 are defined,

Execution of a calculation process, through which the project variable values of the child project variables “Personal experience”, “Dev team experience”, “Component quality” as well as “Number of defects” are calculated by the project control method to be evaluated, and

Calculation of the project control evaluation figure based on the calculated project variable values which represents a measure for the quality of the project control method.

To obtain a good evaluation quality, the Bayesian network 700 should be trained by data records containing the calculated project variable values (“Personal experience”, “Dev. team experience”, “Component quality” as well as “Number of defects”) and measured project variable values (“Personal experience M”, “Dev team experience M”, “Component quality M” as well as “Number of defects M”) as well as measured project control method evaluation figures 701 of earlier projects and/or of the current project.

To this end a further external node 401 (“Personal experience M”, “Dev team experience M”, “Component quality M” as well as “Number of defects M”) is modeled for each child project variable “Personal experience”, “Dev team experience”, “Component quality” and also “Number of defects” to which measured project variable values of the child project variable are assigned, and corresponding dependencies 402 are defined.

Further aspects of an embodiment of the invention are to be examined in the explanations given below.

The prediction of particular project data such as final deadline or residual error rate at a given point in time based on historical data and previous project progress taking into account particular project conditions such as different development sites, integration of OEM shares etc. is highly complex, but is extremely important from the economic standpoint. It is especially desirable to include the data of earlier projects and intermediate results of the project under consideration continuously in order to improve the new predictions.

Because of the size and the heterogeneity of typical projects, e.g. in the area of mobile radio development, estimations of the effort i.e. in the final analysis the empirical values of those responsible (taking into account the resources available) are included almost exclusively. Objectification and comparability, e.g. for optimizing the assignment of tasks to teams, thus become extraordinarily difficult, not least since the assignments are made before these estimates.

In accordance with one embodiment of the invention a module is used which employs artificial intelligence to model the relationships of measurable and influenceable variables, external nodes Ei, modeled, and which uses both historical and also current project data for training. In accordance with one embodiment of the invention, an evaluation machine based on Bayesian networks (BBN), or more generally each function of historical data and results of the previous project progress is used.

In particular the use of BBN allows an advance fixing of the input and output values, i.e. a distribution of the external nodes to input/output to be dispensed with.

The advantages of this type of procedure are as follows:
High flexibility; By training with historical data of comparable projects a better prediction accuracy can be expected than with general formulae
Ongoing project accompaniment allows retroactive control
Simulation of the project progress
Dispensing with fixing the input and output variables in advance: This makes a simple simulation of the project situation with changed paradigms possible, e.g. by how much is a possible delivery date brought forward if the quality required for this is slightly reduced (residual error rate 2/kNLOC instead of 1/kNLOC, with in this example. kNLOC=“kilo net lines of code” serving as a unit for complexity or size for example).

During a project the status achieved and the further planning are checked on an ongoing basis and adapted where necessary. In addition of paradigms such as an original specification to complete at the lowest costs can be modified if for example delays or customer requirements mean that the shortest possible remaining run time for the project is given priority.

If one now considers a method for estimating the further progress the project based on the previous results together with the priority within the time-quality-costs triangle, i.e. should the project for example be completed as quickly as possible or with the optimum quality, the main question relates to the prediction quality with specified general conditions which the method delivers.

Such an evaluation scheme should operate in as linear a manner as possible and include the comparison with known standard methods.

Let zᵢ now be the values predicted by the method M for a (x₁, x₂, . . . , xₙ; y₁, y₂, . . . , yₘ) predicted value.

M:R^{n+m} →R′;x→M(x₁,x₂, . . . ,xₙ;y₁,y₂, . . . ,yₘ)=(z₁,z₂, . . . ,z_{I})

where the xᵢ stands for data from metrics for the ongoing project and yᵢ stands for external parameters such as the specification of the priorities relating to time/quality/costs.

Generally the described problem is equivalent to the definition of a function

f:M→R; M→f(M)

which assigns to a method a (non-negative) value.

Let

D={(x₁,x₂, . . . ,xₙ;y₁,y₂, . . . ,yₘ;Z₁,Z₂, . . . ,Zᵢ)}

be a set of historical data records, the Zᵢ are the actual measured values. One can use normal standard methods such as Gaussian error calculation for example to derive measures of evaluation for the method M over the Δzᵢ:=|zᵢ−Zi | and thereby define such a measurement dimension f. This however does not take account of different units or weightings of the zᵢ and is especially highly non-linear and thus intuitively difficult to detect.

The problem can be resolved by the definition of a suitable Bayesian network (BBN).

Bayesian Networks
Other designations: Graphic models, belief networks, . . .
Definition: A simple graphic notation for conditional independence and thereby for compact specification of complete shared distributions.
Syntax and semantics: A set of nodes, one per random variable
a direct, acyclic graph (connector≈‘influences directly’)
a conditional distribution for each node, given its parents: P(Xij, parents(Xi))

Nodes of such a BBN are (at least) the xᵢ, yᵢ, zᵢ, Zᵢ introduced above and also a node f, which reflects the desired output, i.e. the value figure of the model.

Decisive for a BBN in addition to the topology of the network thus defined is the occupancy of the probability tables (NPT—Node Probability Tables, CPT—Conditional Probability Table). These can either be specified in advance or trained via prespecified data records, i.e. the network can be made to learn them. In accordance with an embodiment of the invention, based on a set of historical and/or fictitious data

D_{training}={(x₁,x₂, . . . ,xₙ;y₁,y₂, . . . ,yₘ;z₁,z₂, . . . ,zᵢ;Z₁,Z₂, . . . ,Zᵢ)}

the network is trained so that it exhibits the desired behavior. In particular the set of data records D_{training} should contain predetermined evaluations for known standard methods and thus allow a classification of the calculated value figure.

The result thus achieved corresponds to intuition (which can be predetermined via the fictitious data records or which in the final analysis was obtained from predecessor projects, that is the historical data,). A desired functional behavior, linear for example, can be predetermined. The result thus obtained contains a calibration to known methods.

The advantages of this type of procedure are as follows:

Comparative evaluation of different methods available for project control. A tool based on this thus improves the options for project control and thereby offers the corresponding potential cost savings or competitive advantages.

Takes into consideration predetermined peripheral conditions, such as minimizing cost as the highest priority

Intuitive, a functional behavior can be defined if desired

Adapted to standard methods.

It is known that the influence of various externally influenceable variables such as number and quality of resources, available time etc. on for example, project run times or product quality differs sharply. As a variant of the Pareto principle one can assume or predict that one will only have to influence some 20% of these variables to achieve 80% of the obtainable effect. Thus the knowledge about and sensitivity of the project data such as residual runtime, quality as a function of the time, etc. depends on influenceable variables.

In accordance with an embodiment of the invention the use of a module based on artificial intelligence, more precisely a BBN, is used for predicting the relevant project data.

This module has a series of external nodes Eᵢ, which serve both as input and also as output nodes (non-entered nodes are determined). Such external nodes are for example. the variables or complexity of subsystems, quality of teams, time remaining until the end of the project or to the end of specific project phases or the residual error rate at a given point in time.

Each node is thus a function of the other functions and naturally of the time. The differential is thus produced from the partial derivations according to the other external nodes in each case multiplied by the relevant differential. In particular the desired sensitivity is the derived variable in each case.

The numerical determination of the desired partial derivations is simple.

In general the sensitivities (=partial derivations) can naturally be determined with each module which allows the calculation of the project variables of interest while varying one parameter and retaining the remaining parameters.

The advantages of this type of procedure are as follows:
Simple determination of the relevant influenceable variables for project control
Simulation of the further project progress based on the analysis of the important influencing variables as a major basis for decision making

The description below is intended to demonstrate an actual possible implementation of a Bayesian network, with the aid of which the occurrence or rectification of errors during the system test phase in a software development process can be predicted. The embodiment described below has the following advantages:
The network model uses a number of identifying metrics which are available during the system test phase to make predictions for the variables of interest
The network model reflects different test phases
The network model is applicable to an incremental development process
The network model provides additional prediction results in order to support the control of system tests

A Bayesian Belief network (BBN)) can be represented as a directed graph in which the nodes depict probabilities, whereas the arrows between the nodes define dependencies. Each node in the graph can contain a specific number of states and features an assigned set of Conditional Probability Distributions (CPD). In general a BBN includes:
Structure (topology)—a set of nodes and directed arrows. Nodes represent variables (events). The arrows represent the relationships between the variables (dependencies).
Content (parameters)
Conditional probability distributions, which are assigned to each node (variable) of the graph. Two specific types of node are defined: “Root” is a node without parents, “leaf” is a node without children.

If discrete variables are provided the CPD can be depicted as Node Probability Table (NPT)) which lists the probability with which a specific node assumes each of its different values for each combination of the values of its parents. For continuous variables each CPD is shown as a probability distribution, for example in the form of a Gaussian distribution. A BBN can also contain nodes of different types. However in this case specific methods must be employed.

The building of a BBN begins with the identification of the relevant variables of the project which are to be modeled. Then the dependencies between the variables are determined. Subsequently the conditional probability distributions (CPDs) are allocated to the network. The initial network should then be tested to verify that it reflects intuition.

The constructed BBN provides a mechanism for probability interference. At the beginning each node has initial probability values (predetermined by an expert or extracted from experience databases). If new knowledge about probabilities is available (so-called facts), the corresponding NPT is modified and its effect on the overall graph investigated (the entire network is recalculated on the basis of the new facts).

A large software system usually consists of many components or subcomponents. Most components are developed and tested independently of each other. During the system test phase all components are integrated, so that the overall system is produced, which is then tested to see that it meets system requirements. System test is usually divided up into the testing of new features and the regression test.

The testing of new features is executed for features which were developed for a new release. Since the features have never previously been tested, new test cases must be developed, based on the requirement specifications. The regression test comprises the execution of test cases which cover the remaining features in order to insure that no functions which functioned previously have been influenced by the changes which have arisen as a result of the introduction of the new features.

The general structure of a possible system test BBN model can be considered as a core model or basis, to which three satellite models, namely development quality model, a new feature test model and also regression test model are linked. Here the development quality model provides a prediction about the number of errors which have been caused by the development process. The new feature test model predicts the effectiveness of the new feature test in detecting errors in the code to be tested.

In a similar manner the regression test model provides a prediction relating to the effectiveness of the regression test in detecting errors in the code to be tested. The basis represents the red thread in the introduction and the removal of errors during the system test phase. It starts with the prediction of the number of errors in the code which enter into the system phase. It then uses the new feature test effectiveness to calculate the errors which have been uncovered during a new feature test phase.

In the same way the regression test effectiveness is used to calculate the errors uncovered in the regression test. Finally the latent defects which are included in the delivery after the system test phase can be derived, assuming that the number of introduced errors or the number of errors detected in the new feature test or the regression test is known.

The definitions of the primary nodes in the basis of follows:

Introduced Defects
Name: Introduced defects
Description: These nodes represent the number of defects in the code which enter into the system test phase. Normally the value can be estimated using the total number of defects which are found in the later phases.
Dependencies: Number of defects in all software components of the system
Variable type: Discrete
Unit: Defs
Range of values: Non-negative integer
Example: 200 defs, which means that there are a total of 200 errors which are hidden in the system before the system test phase begins

Defect Detected in the New Feature Test
Name: Defect detected in the new feature test
Description: This node represents the number of the defects which are discovered during the testing of new features
Dependencies: New feature test efficiency
Variable type: Discrete
Unit: Defs
Range of values: Non-negative integer
Example: 200 defs, which means that a total of 200 defects are found during the new feature test phase

Defects Detected in the Regression Test
Name: Defects detected in the regression test
Description: This node represents the number of defects which are found during regression test
Dependencies: Regression test efficiency
Variable type: Discrete
Unit: Defs
Range of values: Non-negative integer
Example: 200 defs, which means that a total of 200 defects are found during the regression test phase

Latent Defect
Name: Latent defect
Description: This node describes the number of defects which were not uncovered during the system test phase
Dependencies: Introduced defect, defect detected in new feature test, defect detected in regression test
Variable type: Discrete
Unit: Defs
Range of values: Non-negative integer
Example: 200 defs, which means that 200 defects were not uncovered during the system test phase and can the find their way into the delivered version

Details of the three satellite models are described below.

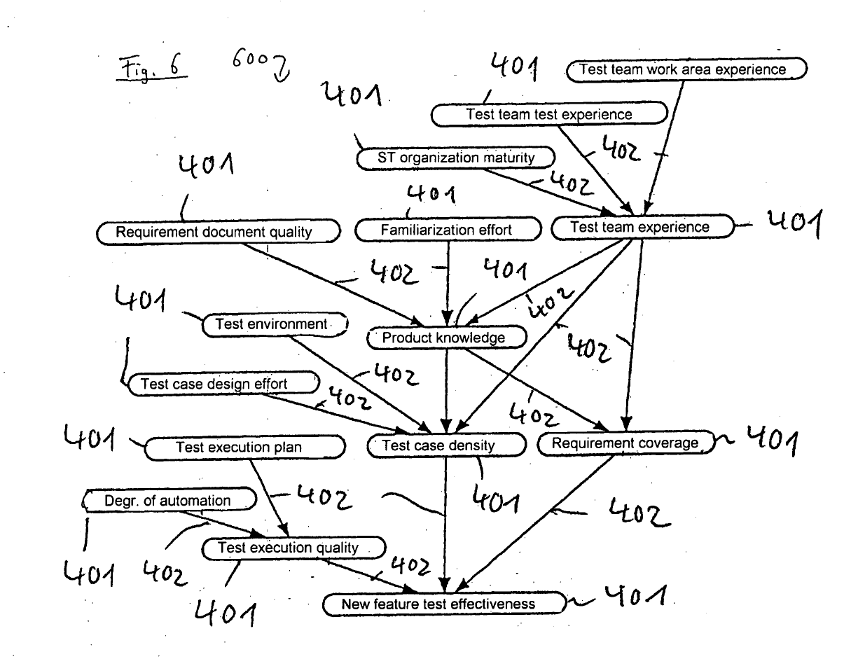

The topology of the new feature test BBN and its node definitions will be introduced below. The model gives a prediction about the ability of the new feature testing to detect errors in a specific software system. Here the value which is to be predicted is referred to as the new feature test effectiveness and identified as the percentage proportion of errors which will be discovered by executing the new feature test. There are three definitive factors of this attribute, namely requirements coverage, test case density and execution quality. These factors are independent of one another, with each having its own dependencies. The overall structure of the new feature test BBN model is shown in FIG. 6.

New Feature Test Effectiveness
Name: New feature test effectiveness
Description: This node specifies how “good” the new feature test is (expressed as the ability to detect errors). This is defined as the ratio of the number of errors which are determined by a new feature testing to the total number of defects present in the software to be tested.
Dependencies: Test execution rate, test case density, requirement coverage
Variable type: Continuous
Range of values: [0.0, 1.0] Floating point number
Example: If the new feature test effectiveness is less than 0.85, this means that 85% of the errors in the software to be tested are determined in the new feature testing.

Test Execution Quality
Name: Test execution quality
Description: This node specifies how good the new feature test suite is in practice. For example these attributes can reflect the influences and factors such as time pressure or high workload for example. The node can be measured using five discrete values: from 1 (weak) to 5 (excellent). The final assessment can be undertaken by experts or managers, taking into account the two main defining factors: Test execution plan and test case automation share.
Dependencies: Test execution plan, test case automation share.
Variable type: Discrete
Unit: NA
Range of values: [1,5] five levels
Example: Level 4 means that the execution quality of the new feature test suite is very good.

Test Case Density
Name: Test case density
Description: This node specifies how many test cases will be executed based on the number of prerequisites that they are testing. This is an important indicator which specifies how well the prerequisites are tested. It is recommended that this attribute be defined as the ratio of the total number of test cases to the total number of prerequisites, as is specified by the following equation
Test case density=total number of test cases/total number of prerequisites
Dependencies: Test case design effort, test environment, product knowledge, test team experience
Variable type: Continuous
Unit: Test cases per prerequisite
Range of values: Positive floating point number
Example: If the value of the test case density is 2.7, then this means that on average an individual prerequisite is tested by 2.7 test cases.

Requirement Coverage
Name: Requirement coverage
Description: This node specifies how well the test environment covers the defined requirements. The cover is defined as a percentage value, as is shown in the following equation: Requirement coverage=number of requirements which are covered by the test cases/total number of prerequisites·100%
Dependencies: Test team experience, product knowledge
Variable type: Continuous
Unit: NA
Range of values: [0%, 100%] floating point number
Example: 100% prerequisite coverage means that all requirements are provided with test cases.

Test Execution Plan
Name: Test execution plan
Description: This node specifies how many attempts are made to execute the new feature test suite. It is recommended that this attribute be measured using the planned effort per test case, as is shown in the following equation: Test execution plan=total effort expended/number of planned test cases
Dependencies: None
Unit: Employee day per test case
Variable type: Continuous
Range of values: Positive floating point number
Example: 0.5 employee days per test case mean that on average an effort of 0.5 employee days are planned for executing an individual test case.

Test Case Automation Share
Name: Test case automation share
Description: This node specifies the degree of automation of the new feature test environment. This is measured using a percentage figure, as defined in the following equation: Test case automation share=total number of automated test cases/total number of test cases 100%
Dependencies: None
Variable type: Continuous
Unit: NA
Range of values: [0%, 100%] floating point number
Example: 50% means that half of the new feature test cases can be executed automatically.

Test Case Design Effort
Name: Test case design effort
Description: This node specifies the effort which is necessary to design the new feature test suite.
Dependencies: None
Variable type: Continuous
Unit: Employee day
Range of values: Positive floating point number
Example: In accordance with a project plan 30 employee days are spent in designing the new feature test environment, thus the value of this node is 30 employee days.

Test Environment
Name: Test environment
Description: This node specifies how good the capability of the environment is for executing the new feature test cases. It is proposed that this value be measured using five discrete values: from 1 (low) to 5 (excellent). The final assessment can be undertaken by experts or managers, taking into account a number of definitive factors such as the overall laboratory environment, test equipment availability, test tools availability etc.
Dependencies: None
Variable type: Discrete
Unit: NA
Range of values: [1,5] 5 levels
Sample: Level 3 means that the overall capability of the new feature test environment is good.

Test Team Experience
Name: Test team experience
Description: This node specifies how good the capability of the test team is, expressed as experience. It is recommended that this attribute be measured using five discrete values: from 1 (beginner) to 5 (expert). The final assessment can be undertaken by experts or managers, taking into account three factors: Test team working area knowledge, test team test experience and system test organization maturity
Dependencies: Test team working area knowledge, test team test experience, system test organization maturity
Variable type: Discrete
Unit: NA
Range of values: [1,5] 5 levels
Example: Experience level 3 means that the test team is very experienced.

Product Knowledge
Name: Product knowledge
Description: This node specifies how well the test team understands the software product to be tested. It is recommended that this attribute be measured using five discrete values: from 1 (low) to 5 (excellent). The final assessment can be undertaken by experts or managers, based on three factors: Documentation quality, familiarization effort and test team experience.
Dependencies: Documentation quality, familiarization effort, test team experience.
Variable type: Discrete
Unit: NA
Range of values: [1,5] 5 levels
Example: Level 3 means that the test team has a good understanding of the software product to be tested.

Test Team Test Experience
Name: Test team test experience
Description: This node specifies the average working experience of the test team. It is recommended that this attribute be measured using the average of the years for which the team members have worked as test engineers.
Dependencies: None
Variable type: Continuous
Unit: Years
Range of values: Non-negative floating point value
Example: 1.5 years, which means that the members of the test team have on average 1.5 years of experience working as test engineers.

Test Team Experience in Area of Work
Name: Test team experience in area of work
Description: This node represents the average experience in a particular product-related area of work of the test team member. This can be measured using the average years worked by the team members in the area of work, for example telecommunications.
Dependencies: None
Variable type: Continuous
Unit: Years
Range of values: Non-negative floating point value
Example: 1.5 years, which means that the members of the test team have an average of 1.5 years working experience in the product-related industrial field.

Familiarization Effort
Name: Familiarization effort
Description: This node specifies how great the effort of the test team is to familiarize itself with the development of the software product to be tested, for example the effort which has been expended in looking through the requirement documents or design documents.
Dependencies: None
Variable type: Continuous
Unit: Employee day
Range of values: Non-negative floating point value
Example: 30 employee days means that the test team has needed a total of 30 employee days of effort to familiarize itself with the development of the product.

Requirement Document Quality
Name: Requirement document quality
Description: This node specifies how good the quality of the requirement document is. It is recommended that this attribute be measured using five discrete values: from 1 (low) to 5 (excellent). The final assessment can be undertaken by experts or managers, based on the definitive factors such as completeness, stability, comprehensibility and availability of the requirement document.
Dependencies: None
Variable type: Discrete
Unit: NA
Range of values: [1,5] 5 levels
Example: Level 3 means that the overall quality of the requirement document is good.

System Test Organization Maturity
Name: System test organization maturity
Description: This node represents the maturity of the organization which bears the responsibility for system testing. A suitable measurement for this attribute is the CMMI level, which can assume five discrete values, beginning from 1 (initial) to 5 (optimized). If possible the TIP (test improvement profile) level should be used since this is more tailored to testability compared to the CMMI level.
Dependencies: None
Variable type: Discrete
Unit: NA
Range of values: [1,5] 5 levels
Example: Level 3 means that the system test organization has passed the CMMI level 3 test.

Regression Test Model

The regression test model allows the capability of the regression test to uncover errors in a specific software system to be predicted. The regression test effectiveness should be predicted in a similar way to the definitions in the new feature test model, defined as the percentage proportion of the errors which is determined during the execution of the regression test. This attribute is influenced directly by the test suite effectiveness (the selected test cases for regression testing) and the test execution ratio. The factors which govern the effectiveness of the test suite are as follows:

Test case density—how “good” the capability of existing test cases is at fully testing the defined requirements.

Requirement coverage—how “well” the existing test cases cover the defined requirements

Test team experience—how “good” is the capability and the experience of the test team

Product knowledge—how “well” does the test team understand the software product to be tested

The decisive factors for the test execution ratio are:

Degree of automation—how many test cases can be executed automatically

Schedule—how great is the planned effort for executing the regression test

The model provides further useful output, a test case selection ratio, which predicts how many existing test cases should have been executed to execute the regression test.

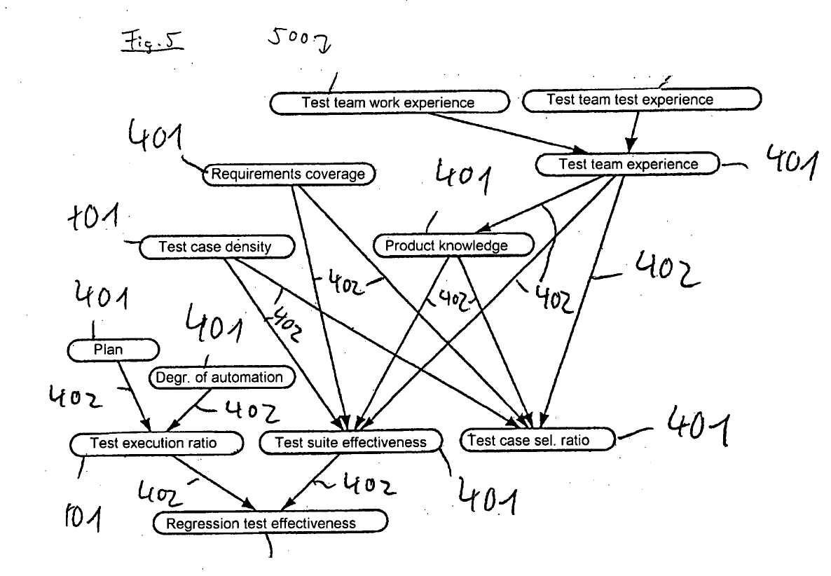

FIG. 5 shows the structure of the regression test model. Detailed definitions of this model are as follows:

Regression Test Effectiveness
Name: Regression test effectiveness
Description: This node specifies how “good” the regression test is, expressed as its capability to detect errors. This is defined as the ratio of the number of defects which are determined by the regression test to the total number of defects in the software to be tested, as is shown in the following equation: Regression test effectiveness=number of defects found by the regression test/total number of defects.
Dependencies: Test case effectiveness, test execution ratio
Variable type: Continuous
Unit: NA
Range of values: [0.0, 1.0] Floating point number
Example: If the regression test effectiveness is 0.6, this means that 60% of the errors in the software to be tested are detected by executing the regression test.

Test Case Effectiveness
Name: Test case effectiveness
Description: This node represents the capability of the test cases which were selected for the regression test to uncover errors. This is defined as the ratio of the number of defects which would be uncovered if all selected test cases were to be executed for regression testing to the total number of defects in the software to be tested.
Dependencies: Test team experience, product knowledge, test case density, requirement coverage
Variable type: Continuous
Unit: NA
Range of values: [0.0, 1.0] Floating point number
Example: If the test case effectiveness is 0.6, this means that 60% of the errors in the software to be tested will be detected by all test cases in the regression test environment being executed.

Test Case Selection Ratio
Name: Test case selection ratio
Description: This node specifies how many existing test cases should have been selected to execute regression testing. This is defined as a percentage figure, as shown in the following equation: Test case selection ratio=total number of selected test cases/total number of available test cases ˜100%.
Dependencies: Test team experience, product knowledge, test case density, requirement coverage
Variable type: Continuous
Unit: NA
Range of values: [0%, 100%] floating point number
Example: 60%, which means, that 60% of the available test cases should have been executed to ensure the quality of the regression testing.

Test Execution Ratio
Name: Test execution ratio
Description: This node specifies how well the regression test environment can be executed in practice. As a result of the influence of a tight time schedule, not all the tests cases which are provided for the regression test can be executed in practice. It is therefore recommended that the actual test case execution ratio be used to measure this attribute, using the following equation: Test execution ratio=total number of executed test cases/total number of selected test cases 100%
Dependencies: Schedule automation level
Variable type: Continuous
Unit: NA
Range of values: [0%, 100%] floating point number
Example: 80% execution rate means that 80% of the selected test cases were actually executed during the regression test phase

Test Team Experience
Name: Test team experience
Description: This node represents the test team experience, which represents an important indicator of the test capability of the team. It is recommended that this attribute be measured using 5 discrete values: from 1 (beginner level) to 5 (expert level). The final assessment can be undertaken by experts or managers, taking into account the average experience in the area of work and the test experience of the team member.
Dependencies: Test team experience in work area, test team test experience
Variable type: Discrete
Unit: NA
Range of values: [1,5] 5 levels
Example: Level 3 means that the test team is very experienced

Test Team Test Experience
Name: Test team test experience
Description: This node represents the average work experience of the test team. It is recommended that this attribute be measured using the average of the years for which the team members have worked as test engineers.
Dependencies: None
Variable type: Continuous
Unit: Years
Range of values: Non-negative floating point value
Example: 1.5 years, which means that the members of the test team have on average 1.5 years of experience working as test engineers.

Test Team Experience in Area of Work
Test team experience in area of work
This node specifies the average work experience of the test team member in working in the industrial field of the product. This can be measured using the average years of work of the team member in the area of work, for example in telecommunications.
Dependencies: None
Variable type: Continuous
Unit: Years
Range of values: Non-negative floating point value
Example: 1.5 years, which means that the members of the test team have on average 1.5 years of experience working in the industrial field of the product.

Product Knowledge
Name: Product knowledge
Description: This node specifies how well the test team understands the product to be tested. To ensure the quality of the regression test, the team must possess a good understanding of the functional principles, the features or functions. It is recommended that this attribute be measured using 5 discrete values: from 1 (beginner level) to 5 (expert level). The final assessment can be undertaken by experts or managers, taking into consideration the experience or capability of the test team.
Dependencies: Test team experience
Variable type: Discrete
Unit: NA
Range of values: [1,5] 5 levels
Examples: Level 3 means that the test team has a good understanding of the system to be tested

Test Case Density
Name: Test case density
Description: This node specifies how many test cases exist based on the number of prerequisites to be tested. This is an important indicator of how well the requirements will be tested. It is recommended that this attribute be defined as the total number of test cases to the total number of requirements, as is shown by the following equation: Test case density=total number of test cases/total number of requirements
Dependencies: None
Variable type: Continuous
Unit: Test cases per prerequisite
Range of values: Positive floating point number
Example: If the value of the test case density is 2.7, then this means that on average an individual requirement is tested by 2.7 existing test cases.

Requirement Coverage
Name: Requirement coverage
Description: This node specifies how well the existing test cases cover the defined requirements. The requirement is defined as a percentage figure, as specified in the following equation: Requirement coverage=number of prerequisites which is covered by test cases/total number of prerequisites 100%
Dependencies: None
Variable type: Continuous
Unit: NA
Range of values: [0%, 100%] floating point number
Example: 100% requirement coverage means that all requirements are provided with existing test cases.

Plan
Name: Plan
This node specifies how many attempts are planned to execute the regression test and can be viewed as an indicator of time pressure. It is recommended that this attribute be measured using the planned effort per regression test case, as specified in the following equation Regression test case=overall planned effort/number of planned regression test cases
Dependencies: None
Unit: Employee day per test case
Variable type: Continuous
Range of values: Positive floating point number
Example: 0.5 employee days per test case means for example that an effort of 0.5 employee days is planned-in for the execution of an individual regression test case

Level of Automation
Name: Level of automation
Description: This node specifies the degree of automation of the regression test environment and is measured using a percentage proportion, as is specified in the following equation: Level of automation=total number of automated test cases/total number of test cases times 100%
Dependencies: None
Variable type: Continuous
Unit: NA
Range of values: [0%, 100%] floating point number
Sample: 50% means that half of the regression test cases can be executed automatically.

Component Development Quality Prediction Model

This submodel is used to predict the development quality of an individual component. The result is expressed as the number of defects which are hidden in this component. By summing the number of the effects of all components of the system the total number of defects in the system can be estimated, which is an important input of the basic model.

FIG. 4 shows the structures of the component quality prediction model. Here the number of errors in a software component is calculated by multiplying the component size by the component quality, which is measured using the defect density metrics. The main aspects which define the component quality are code complexity, age of code, the quality of the last release, and the experience of the development team. Furthermore two factors influence the development team experience, namely the personal experience and the maturity of the organization. The personal experience is calculated from two factors here: Experience in the area of work and programming language skills, representing the relevant working experience in the product-related area of work and in the programming language respectively.

Number of Defects
Name: Number of defects
Description: This node represents the total number of defects in the software component to be tested which occur during the development phase. Normally the value of this attribute is defined using the total number of defects in the component, which are found in a later phase.
Dependencies: Component quality, component size
Variable type: Discrete
Unit: Defs
Range of values: Non-negative integer
Examples: 200 defs, which means, that 200 defects are present in the component after the development phase

Component Size
Name: Component size
Description: This node represents the size of the component to be tested. It is recommended that size metrics such as LOC or function points be used in order to measure this attribute.
Dependencies: None
Variable type: Discrete
Unit: KLOC (if LOC is employed for size measurement)
Range of values: Non-negative integer
Example: 150 KLOC, which means that the size of the component is 150 KLOC.

Component Quality
Name: Component quality
Description: This node represents the quality of the components to be investigated. Here the defect density is used to measure this attribute.
Dependencies: Code complexity, age of code, quality of the previous version, team experience
Variable type: Continuous
Unit: Defs/KLOC
Range of values: Non-negative floating point value
Example: 20 Defs/KLOC, which means that the defect density of the software component which is tested amounts to 20 defects per KLOC.

Code Complexity
Name: Code complexity
Description: This node represents the code complexity of the component to be tested. A number of complexity metrics can be used to define this attribute, for example McCabe Cyclomatic Complexity, or function points. In practice, if no direct complexity metrics are available for the component, it is recommended that size metrics such as replacement be used, since the size is also an indicator of the intrinsic complexity of a part of the code.
Dependencies: None
Variable type: Discrete
Unit: KLOC (if LOC is employed for size/complexity measurement)
Range of values: Non-negative integer

Age of Code
Name: Age of code
Description: This node represents the age of the code in the software component to be tested. This is used to measure the extent to which the source code of the component was changed in the new version compared to the previous version. It is recommended that the following equation be used to calculate the age of code: Age of code=total amount of unchanged code/total amount of code
Dependencies: None
Variable type: Continuous
Unit: NA
Range of values: (0.0, 1.0] floating point number
Example: If the age of code is 0.5, this means that, in the new version, 50% of the code has been changed or replaced in the component.

Quality of the Previous Version
Name: Quality of the previous version
Description: This node specifies the quality of the component of the previous version. This attribute is measured in a similar manner to component quality. In practice the value of this node can be estimated using comparable metrics such as the PR number per KLOC for example
Dependencies: None
Variable type: Continuous
Unit: Defs/KLOC
Range of values: Non-negative floating point value
Example: 30 defs/KLOC which means that in the previous version of the component to be investigated there was an error density of 30 errors per KLOC.

Development Team Experience
Name: Development team experience
Description: This node specifies the experience of the development team as regards the component to be researched. This is an important indicator of the development team capability. It is recommended that this attribute be defined using five discrete values ranging from 1 (beginner) to 5 (expert). The final assessment can be undertaken by an expert or a manager, taking into account the two previously-mentioned factors: Personal experience and maturity of the organization.
Dependencies: Personal experience, maturity of the organization
Variable type: Discrete
Unit: NA
Range of values: [1,5] 5 levels
Example: Experience level 3 means that the development team has experience up to the mid level.

Organization Maturity
Name: Organization maturity
Description: This node represents the maturity of the development organization. A suitable measurement option for this attribute is the CMMI level which can assume five discrete values, namely from 1 (initial) to 5 (optimized).
Dependencies: None
Variable type: Discrete
Unit: NA
Range of values: [1,5] 5 levels
Example: Level 3 means that the development organization has passed the CMMI level 3 check.

Personal Experience
Name: Personal experience
Description: This node represents the average personal experience of the development team, which can be evaluated using two aspects: the experience in the product-related industrial working area and in the programming language. It is recommended that the attribute be measured using five discrete values: from 1 (beginner) to 5 (expert). The final assessment can be undertaken by experts or managers, taking into account the average of years worked and programming experience of the team member.
Dependencies: Language experience, work area experience
Variable type: Discrete
Unit: NA
Range of values: [1,5] 5 levels
Example: Level 5 means that the development team members have an excellent knowledge of the developed software product as well as of the programming language used in the current project.

Language Experience
Name: Language experience
Description: This node represents the average programming language experience of the development team. It is recommended that this attribute be measured using the average of the years for which the team members have worked as software developers using the programming language which is used in the current project.
Dependencies: None
Variable type: Continuous
Unit: Years
Range of values: Non-negative floating point value
Example: 1.5 years means that the members of the development team have an average of 1, 5 years programming experience with the programming language used in the current project.

Knowledge of Area of Work
Name: Knowledge of area of work
Description: This node represents the average work experience of the development team in the product-related industrial field. This can be measured using the average of the years which team members have spent in the given area of work, for example telecommunications.
Dependencies: None
Variable type: Continuous
Unit: Years
Range of values: Non-negative floating point value
Example: 1.5 years, which means that the members of the development team have an average of 1.5 years of working experience in the product-related industrial field.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks™, cassette tapes, and removable hard disks; media with a built-in rewriteable nonvolatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. Method for improving project control of a project, comprising:
defining of a Bayesian network, by modeling as external nodes of the Bayesian network each project variable of the project able to be at least one of measured and influenced, and defining dependencies between the modeled nodes;
executing an assignment process by which project variable values which show possible values of the project variables which represent the nodes are assigned to the modeled nodes;
calculating the project variable values of at least one project variable based on project variable values of at least one other project variable and the defined dependencies between the project variables; and
controlling the project using the calculated project variable values.

2. Method as claimed in claim 1, wherein the Bayesian network is trained by at least one of project variable values of earlier projects and project variable values of a current project.

3. Method as claimed in claim 1, wherein each child project variable is allocated a probability distribution, which assigns probability values to the project variable values which the associated parent project variables can assume, with the probability values specifying the probability with which, if certain project variable values of the parent project variables are present, specific project variable values of the child project variable will occur.

4. Method as claimed in claim 3, wherein the Bayesian network is trained by the probability distributions assigned to the child project variables being changed.

5. Method as claimed in claim 1, wherein external nodes are modeled for the project variables time, quality and costs.

6. Method for improving the project control of a project, comprising:
defining a Bayesian network, by modeling as external nodes of the Bayesian network each project variable of the project able to be at least one of measured and influenced, and defining dependencies between the modeled nodes;
executing an assignment process by which project variable values which show possible values of the project variables which represent the nodes are assigned to the modeled nodes;
determining a sensitivity of a first project variable in respect of a second project variable by determining how much a project variable value of the first child project variable changes when a project variable value of the second project variable changes;
controlling the project using the sensitivity determined.

7. Method as claimed in claim 6, wherein the first project variable is allocated a mathematical function which describes the first project variable and is a function of the project variable value of the second project variable.

8. Method as claimed in claim 7, wherein the sensitivity of the first project variable is determined by deriving the mathematical function of the first project variable partly according to the second project variable, with the partial derivation representing the sensitivity.

9. Method for evaluation of the quality of a project control method in which project variable values of first project variables are calculated depending on project variable values of second project variables, the method comprising:
defining a Bayesian network, at least one first project variable of the project control method to be evaluated as well as a project control evaluation method to be calculated being modeled as external nodes of the Bayesian network and dependencies between the modeled external nodes being defined;
executing a calculation process through which the project variable values of the at least one first project variable are calculated by the project control method to be evaluated; and
calculating the project control evaluation figure based on the calculated project variable values, which represents a measure for the quality of the project control method.

10. Method as claimed in claim 9, wherein, for each first project variable which was modeled as an external node, a further external node is modeled to which a measured project variable value of the first project variable is assigned, with dependencies being defined between the further external nodes and the already modeled nodes.

11. Method as claimed in claim 9, wherein the project control methods to be modeled comprise:
defining a Bayesian network, by modeling as external nodes of the Bayesian network each project variable of the project able to be at least one of measured and influenced, and defining dependencies between the modeled nodes;
executing an assignment process by which project variable values which show possible values of the project variables which represent the nodes are assigned to the modeled nodes;
calculating the project variable values of at least one first project variable based on project variable values of a second project variable and the defined dependencies between the project variables; and
controlling the project using the calculated project variable values.

12. Method as claimed in claim 9, wherein all child project variables and all parent project variables of the project control method to be evaluated are modeled as external nodes.

13. Method as claimed in claim 9, wherein the Bayesian network is trained by data records containing calculated project variable values and measured project variable values as well as measured project control method evaluation figures of at least one of earlier projects and the current project.

14. Method as claimed in claim 9, wherein each child project variable is allocated a probability distribution, which assigns probability values to the project variable values which the associated parent project variables can assume, with the probability values specifying the probability with which, if certain project variable values of the parent project variables are present, specific project variable values of the child project variable will occur.

15. Method as claimed in claim 14, wherein the Bayesian network is trained by the probability distributions assigned to the child project variables being changed.

16. Device for improving the project control of a project, comprising:
means for defining a Bayesian network, through which each project variable of the project able to be at least one of measured and influenced is able to be modeled as an external node of the Bayesian network, and for defining dependencies between the modeled nodes;
means for executing an assignment process by which project variable values which show possible values of the project variables which represent the nodes are assigned to the modeled nodes;
means for calculating the project variable values of at least one project variable based on project variable values of at least one other project variable and the defined dependencies between the project variables; and
means for controlling the project using the calculated project variable values.

17. Device as claimed in claim 16, wherein the Bayesian network is trained by project variable values of at least one of earlier projects and project variable values of a current project.

18. Device as claimed in claim 16, wherein each child project variable is allocated a probability distribution, which assigns probability values to the project variables which the associated parent project variables can assume, with the probability values specifying the probability with which, if certain project variable values of the parent project variables are present, specific project variable values of the child project variable will occur.

19. Method as claimed in claim 18, wherein the Bayesian network is able to be trained by changing the probability distributions allocated to the child project values.

20. Device as claimed in claim 16, wherein external nodes are modeled for the project variables time, quality and costs.

21. Device for improving the project control of a project, comprising:
means for defining a Bayesian network, through which each project variable of the project able to be at least one of measured and influenced is able to be modeled as an external node of the Bayesian network, and for defining dependencies between the modeled nodes;
means for executing an assignment process by which project variable values which show possible values of the project variables which represent the nodes are assigned to the modeled nodes;
means for determining a sensitivity of a first project variable in respect of a second project variable by determining how greatly a project variable value of the first child project variable changes when a project variable value of the second project variable changes; and
means for controlling the projects using the determined sensitivity.

22. Device as claimed in claim 21, wherein the first project variable is allocated a mathematical function which describes the first project variable and is a function of the project variable value of the second project variable.

23. Device as claimed in claim 22, wherein the sensitivity of the first project variable is determined by deriving the mathematical function of the first project variable partly according to the second project variable, with the partial derivation representing the sensitivity.

24. Device for evaluation of quality of a project control method in which project variable values of first project variables are calculated depending on project variable values of second project variables, the device comprising:
means for defining a Bayesian network, through which at least one first project variable of the project control method to be evaluated as well as a project control evaluation method to be calculated are able to be modeled as external nodes of the Bayesian network and for defining dependencies between the modeled external nodes;
means for executing a calculation process through which the project variable values of the at least one first project variable are calculated by the project control method to be evaluated, and through which, based on the calculated project variable values, the project control evaluation figure is calculated which represents a measure for the quality of the project control method.

25. Device as claimed in claim 24, wherein a further external node can be modeled by the means for defining a Bayesian network for each first project variable which was modeled as an external node, to which a measured project variable value is assigned, with dependencies being able to be defined between the further external nodes and already modeled nodes.

26. Device as claimed in claim 24, wherein the project control methods to be modeled comprise:
defining a Bayesian network, by modeling as external nodes of the Bayesian network each project variable of the project able to be at least one of measured and influenced, and defining dependencies between the modeled nodes,
executing an assignment process by which project variable values which show possible values of the project variables which represent the nodes are assigned to the modeled nodes,
calculating the project variable values of at least one first project variable based on project variable values of a second project variable and the defined dependencies between the project variables, and
controlling the project using the calculated project variable values.

27. Device as claimed in claim 24, wherein all child project variable values and all parent project variables of the project control method to be evaluated are able to be modeled as external nodes by the means for defining a Bayesian network.

28. Device in accordance with claim 24, wherein the Bayesian network is able to be trained by data records containing calculated project variable values and measured project variable values as well as measured project control method evaluation figures of at least one of earlier projects and the current project.

29. Device in accordance with claim 24, wherein each child project variable is allocated a probability distribution, which assigns probability values to the project variables which the associated parent project variables can assume, with the probability values specifying the probability with which, if certain project variable values of the parent project variables are present, specific project variable values of the child project variable will occur.

30. Device as claimed in claim 29, wherein the Bayesian network is able to be trained by changing the probability distributions allocated to the child project values.

31. Computer readable medium including programs or program modules which, when executed on a computer or a DSP, executes a method for improving the control of a project, comprising:
defining a Bayesian network, by modeling as external nodes of the Bayesian network each project variable of the project able to be at least one of measured and influenced, and defining dependencies between the modeled nodes;
executing an assignment process by which project variable values which show possible values of the project variables which represent the nodes are assigned to the modeled nodes;
calculating the project variable values of at least one project variable based on project variable values of at least one other project variable and the defined dependencies between the project variables; and
controlling the project using the calculated project variable values.

32. Computer readable medium including programs or program modules which, when executed on a computer or a DSP, executes a method for improving the control of a project, comprising:
defining a Bayesian network, by modeling as external nodes of the Bayesian network each project variable of the project able to be at least one of measured and influenced, and defining dependencies between the modeled nodes;
executing an assignment process by which project variable values which show possible values of the project variables which represent the nodes are assigned to the modeled nodes;
determining a sensitivity of a first project variable in respect of a second project variable by determining how much a project variable value of the first child project variable changes when a project variable value of the second project variable changes; and
controlling the project using the sensitivity determined.

33. Computer readable medium including programs or program modules which, when executed on a computer or a DSP, executes a method for evaluation of the quality of a project control method, in which project variable values of first project variables are calculated depending on project variable values of second project variable, comprising:
defining a Bayesian network, in that at least one first project variable of the project control method to be evaluated as well as a project control evaluation method to be calculated are modeled as external nodes of the Bayesian network and dependencies between the modeled external nodes are defined;
executing a calculation process through which the project variable values of the at least one first project variable are calculated by the project control method to be evaluated; and
calculating the project control evaluation figure based on the calculated project variable values which represents a measure for the quality of the project control method.

34. A computer readable medium including program segments for, when executed on a computer device, causing the computer device to implement the method of claim 1.

35. A computer program product including program segments for, when executed on a computer device, causing the computer device to implement the method of claim 1.

36. A computer readable medium including program segments for, when executed on a computer device, causing the computer device to implement the method of claim 6.

37. A computer program product including program segments for, when executed on a computer device, causing the computer device to implement the method of claim 6.

38. A computer readable medium including program segments for, when executed on a computer device, causing the computer device to implement the method of claim 9.

39. A computer program product including program segments for, when executed on a computer device, causing the computer device to implement the method of claim 9.
